(19) United States
(12) Patent Application Publication
(10) Pub. No.: US 2017/0148417 A1
(43) Pub. Date: May 25, 2017

(54) ELECTRONIC DEVICE THAT CONTROLS DRIVING FREQUENCY AND OPERATION METHOD THEREOF

(71) Applicant: Samsung Electronics Co., Ltd., Gyeonggi-do (KR)

(72) Inventors: Joo-Hong LEE, Seoul (KR); Ho-Up SONG, Gyeonggi-do (KR); Soo-Lyun KIM, Gyeonggi-do (KR)

(73) Assignee: Samsung Electronics Co., Ltd.

(21) Appl. No.: 15/360,319

(22) Filed: Nov. 23, 2016

(30) Foreign Application Priority Data
Nov. 25, 2015 (KR) 10-2015-0165817

(51) Int. Cl. G09G 5/00; G09G 5/393; H04B 1/3827

(52) U.S. Cl. CPC G09G 5/008; H04B 1/3827; G09G 5/393; G09G 2320/029

(57) ABSTRACT

Disclosed is an electronic device that includes a first processor that monitors whether screen updating is delayed based on a reference time associated with screen updating and generates a control signal that controls a screen updating time based on whether the screen updating is delayed, and a clock managing unit that controls a clock that is supplied to the electronic device in response to the control signal.

### PRIORITY

This application claims priority under 35 U.S.C. 517 119(a) to Korean Patent Application Serial No. 10-2015-0165817, which was filed in the Korean Intellectual Property Office on Nov. 25, 2015, the contents of which are incorporated herein by reference.

### BACKGROUND

1. Field of the Disclosure

The present disclosure relates generally to an electronic device that controls a driving frequency, and more particularly, to an electronic device and an operation method thereof, which control a driving frequency that prevents a screen disconnection of the electronic device .

2. Description of the Related Art

Recently, mobile electronic devices may dynamically control a driving voltage and a driving frequency based on the degree of the load on a system. For example, a mobile electronic device may dynamically control a driving voltage and a driving frequency in order to execute an operation associated with a predetermined application with an optimized performance .

To provide an optimized performance, the mobile electronic device may increase a frequency that is supplied to a central processing unit (CPU), when the performance of each application is deteriorated or when a performance deterioration event occurs due to the load of the entire system. However, when a decrease in the performance occurs due to the load on the system at a predetermined point in time, the mobile electronic device may not effectively cope with the deterioration. For example, when the screen disconnection of image data and the deterioration in a frame per second (FPS) occur, the mobile electronic device may not effectively cope with the screen disconnection or the deterioration in the FPS. Also, screen updating or frame updating performance may not improve in real time due to the load on the CPU, at a predetermined point in time.

Therefore, there is a need in the art for a method of improving the drawbacks that are associated with the screen disconnection and the deterioration in a FPS at a predetermined point in time.

### SUMMARY

The present disclosure has been made to address the above-mentioned problems and disadvantages, and to provide at least the advantages described below.

Accordingly, an aspect of the present disclosure is to provide an electronic device and an operation method thereof, which monitor screen updating and control a driving frequency based on a result of monitoring to prevent a screen of the electronic device from disconnecting.

According to an aspect of the present disclosure, an electronic device that controls a driving frequency includes a first processor that monitors whether screen updating is delayed based on a reference time associated with the screen updating, and generates a control signal that controls a screen updating time based on whether the screen updating is delayed, and a clock managing unit that controls a clock that is supplied to the electronic device in response to the control signal.

According to another aspect of the present disclosure, an operation method of an electronic device includes measuring a screen updating time, and monitoring whether screen updating is delayed based on a reference time associated with the screen updating 5 and the measured time, and controlling a clock supplied to the electronic device, so as to control the screen updating time based on whether the screen updating is delayed.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a block diagram of an electronic device and a network according to embodiments of the present disclosure;

FIG. 2 is a block diagram of an electronic device according to embodiments of the present disclosure;

FIG. 3 is a block diagram of a program module according to embodiments of the present disclosure;

FIG. 4 schematically illustrates an electronic device according to embodiments of the present disclosure;

FIG. 5 illustrates a method of controlling a time associated with screen updating according to an embodiment of the present disclosure;

FIG. 6 illustrates a method of monitoring a time associated with screen updating according to an embodiment of the present disclosure;

FIG. 7 illustrates an operation method of an electronic device according to an embodiment of the present disclosure;

FIG. 8 illustrates an operation method of an electronic device according to another embodiment of the present disclosure;

FIG. 9 illustrates an operation method of a monitoring module according to an embodiment of the present disclosure;

FIG. 10 illustrates an operation method of a monitoring module according to another embodiment of the present disclosure;

FIG. 11 illustrates an operation method of a monitoring module according to another embodiment of the present disclosure;

FIG. 12 illustrates screen updating with respect to each of the frames included in image data according to embodiments of the present disclosure;

FIG. 13 illustrates a change in a clock frequency by a monitoring module according to embodiments of the present disclosure; and

FIG. 14 illustrates a change in an FPS by a monitoring module according to embodiments of the present disclosure.

### DETAILED DESCRIPTION OF EMBODIMENTS OF THE PRESENT DISCLOSURE

Hereinafter, embodiments of the present document will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements. A detailed description of known functions and/or configurations will be omitted for the sake of clarity and conciseness.

As used herein, the expressions “have”, “may have”, “include”, or “may include” refer to the existence of a corresponding feature, such as a numeral, function, operation, or component, and do not exclude one or more additional features.

In the present disclosure, the expressions “A or B”, “at least one of A or/and B”, or “one or more of A or/and B” may include all possible combinations of the items listed. For example, the expressions “A or B”, “at least one of A and B”, and “at least one of A or B” refer to all of (1) including at least one A, (2) including at least one B, and (3) including all of at least one A and at least one B.

The expressions “a first”, “a second”, “the first”, and “the second” used in embodiments of the present disclosure may modify various elements regardless of the order and/or the importance, are used to distinguish one element from the other elements, and do not limit the corresponding components. For example, a first user device and a second user device indicate different user devices although both are user devices. In addition, a first element may be referred to as a second element, and a second element may be referred to as a first element without departing from the scope of the present disclosure.

It should be understood that when an element, such as such as a first element, is referred to as being operatively or communicatively “connected,” or “coupled,” to another element, such as such as a second element, the first element may be directly connected or coupled directly to the second element or a third element may be interposed between the first and second elements. In contrast, it may be understood that when the first element is referred to as being “directly connected,” or “directly coupled” to the second element, there is no third element interposed between the first and second elements.

The expression “configured to” used in the present disclosure may be used interchangeably with “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may indicate that the device, together with other devices or components, “is able to”. For example, the phrase “processor adapted (or configured) to perform A, B, and C” may indicate a dedicated or embedded processor only for performing the corresponding operations or a generic-purpose processor, such as central processing unit (CPU) or application processor (AP) that can perform the corresponding operations by executing one or more software programs stored in a memory device.

The terms used in the present disclosure are only used to describe specific embodiments, and are not intended to limit the present disclosure. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the same meanings as the contextual meanings in the relevant field of art, and are not to be interpreted to have ideal or excessively formal meanings unless clearly defined in the present disclosure. In some cases, the terms defined in the present disclosure should not be interpreted to exclude embodiments of the present disclosure.

An electronic device according to embodiments of the present disclosure includes at least one of a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a motion pictures experts group (MPEG)-1 audio layer-3 (MP3) player, a mobile medical device, a camera, and a wearable device. According to embodiments, the wearable device includes at least one of an accessory type, such as a watch, a ring, a bracelet, an anklet, a necklace, a glasses, a contact lens, or a head-mounted device (HMD), a fabric or clothing integrated type, such as electronic clothing, a body-mounted type, such as a skin pad or tattoo, and a bio-implantable type, such as an implantable circuit.

According to some embodiments, the electronic device may be a home appliance. The home appliance includes at least one of a television, a digital video disk (DVD) player, an audio, a refrigerator, an air conditioner, a vacuum cleaner, an oven, a microwave oven, a washing machine, an air cleaner, a set-top box, a home automation control panel, a security control panel, a TV box, such as Samsung HomeSync™, Apple TV™, or Google TV™, a game console, such as Xbox™ or PlayStation™, an electronic dictionary, an electronic key, a camcorder, and an electronic photo frame.

According to other embodiments, the electronic device includes at least one of various medical devices, such as various portable medical measuring devices including a blood glucose monitoring device, a heart rate monitoring device, a blood pressure measuring device, and a body temperature measuring device, a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment devices, electronic devices for a ship, such as a navigation device and a gyro-compass, avionics, security devices, an automotive head unit, a robot for home or industry, an automatic teller machine (ATM), a point of sales (POS) device in a shop, or Internet of Things (IoT)devices, such as a light bulb, various sensors, an electric or gas meter, a sprinkler device, a fire alarm, a thermostat, a streetlamp, a toaster, sporting goods, a hot water tank, a heater, and a boiler.

According to other embodiments, the electronic device includes at least one of a part of furniture or a building/structure, an electronic board, an electronic signature receiving device, a projector, and various types of measuring instruments, such as a water meter, an electric meter, a gas meter, and a radio wave meter. The electronic device according to embodiments of the present disclosure may be a combination of one or more of the aforementioned various devices. The electronic device according to some embodiments of the present disclosure may be a flexible device. The electronic device according to an embodiment of the present disclosure is not limited to the aforementioned devices, and includes a new electronic device according to the development of new technologies.

As used herein, the term “user” indicates a person who uses an electronic device or an artificial intelligence electronic device that uses an electronic device.

An electronic device that controls a driving frequency, according to embodiments of the present disclosure, monitors screen updating, and controls a driving frequency of the electronic device when a result of monitoring indicates that screen updating occurs, so as to prevent the disconnection of a screen that is displayed in the electronic device.

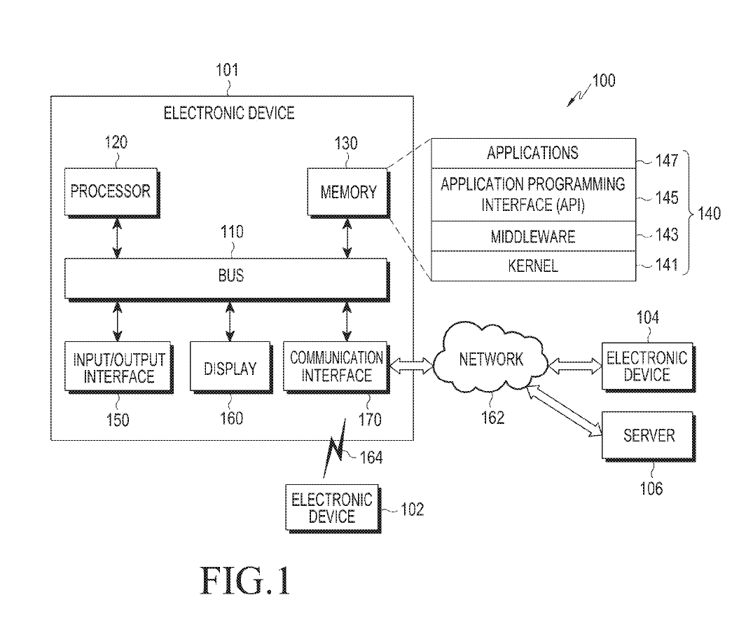

FIG. 1 illustrates an electronic device 101 in a network environment 100, according to embodiments of the present disclosure. The electronic device 101 includes a bus 110, a processor 120, a memory 130, an input/output interface 150, a display 160, and a communication interface 170. The electronic device 101 may omit at least one of the above components or may further include other components.

The bus 110 includes a circuit that interconnects the components 110 to 170 and delivers communication, such as a control message and/or data between the components.

The processor 120 includes one or more of a central processing unit (CPU), an application processor (AP), and a communication processor (CP). The processor 120 performs operations or data processing relating to the control and/or communication of at least one other component of the electronic device 101.

The memory 130 includes a volatile memory and/or a non-volatile memory. The memory 130 stores instructions or data related to at least one other component of the electronic device 101. According to an embodiment of the present disclosure, the memory 130 may store software and/or a program 140. The program 140 includes a kernel 141, middleware 143, an application programming interface (API) 145, and/or applications programs applications 147. At least some of the kernel 141, the middleware 143, and the API 145 may be referred to as an Operating System (OS).

The kernel 141 controls or manages system resources, such as the bus 110, the processor 120, and the memory 130 that are used for performing an operation or function implemented by the other programs, such as the middleware 143, the API 145, or the applications 147. The kernel 141 provides an interface through which the middleware 143, the API 145, or the applications 147 may access the individual components of the electronic device 101 to control or manage the system resources.

The middleware 143 serves as an intermediary for allowing the API 145 or the applications 147 to communicate with the kernel 141 to exchange data.

In addition, the middleware 143 processes one or more task requests received from the applications 147 according to priorities thereof. For example, the middleware 143 may assign priorities for using the system resources of the electronic device 101 to at least one of the applications 147. For example, the middleware 143 performs scheduling or load balancing on the one or more task requests by processing the one or more task requests according to the priorities assigned thereto.

The API 145 is an interface through which the applications 147 control functions provided from the kernel 141 or the middleware 143, and includes at least one interface or function for file control, window control, image processing, text control.

The input/output interface 150 serves as an interface that may transfer instructions or data input from a user or another external device to the other components of the electronic device 101. The input/output interface 150 outputs commands or data received from other components of the electronic apparatus 101 to the user or another external device.

The display 160 includes a liquid crystal display (LCD), a light-emitting diode (LED) display, an organic light-emitting diode (OLED) display, a micro electro mechanical systems (MEMS) display, or an electronic paper display. The display 160 displays various types of contents, such as text, images, videos, icons, or symbols for the user. The display 160 includes a touch screen, and receive a touch input, a gesture input, a proximity input, or a hovering input using an electronic pen or a user's body part.

For example, the communication interface 170 sets communication between the electronic device 101 and an external device, such as a first electronic device 102, a second electronic device 104, or a server 106, and is connected to a network 162 through wireless or wired communication to communicate with an external device.

The wireless communication may use at least one of long term evolution (LTE), LTE-advanced (LTE-A), code division multiple access (CDMA), wideband CDMA (WCDMA), universal mobile telecommunications system (UMTS), wireless broadband (WiBro), and global system for mobile communications (GSM), as a cellular communication protocol.

In addition, the wireless communication includes a short range communication 164. The short-range communication 164 includes at least one of Wi-Fi, Bluetooth™, near field communication (NFC), and a global navigation satellite system (GNSS). The GNSS includes at least one of a global positioning system (GPS), a Beidou navigation satellite system, a european global satellite-based navigation system (Galileo), according to a use area or a bandwidth, for example.

In the present disclosure, the “GPS” may be interchangeably used with the “GNSS” . The wired communication includes at least one of a universal serial bus (USB), a high definition multimedia interface (HDMI), recommended standard 232 (RS-232), and a plain old telephone service (POTS). The network 162 includes at least one of communication networks, such as a computer network, such as a local area network (LAN) or a wide area network (WAN), the Internet, and a telephone network.

Each of the first and second external electronic devices 102 and 104 may be of a type that is identical to, or different from, that of the electronic device 101. According to an embodiment of the present disclosure, the server 106 includes a group of one or more servers. All or some of the operations performed by the electronic device 101 may be performed by another electronic device or a plurality of electronic devices. When the electronic device 101 has to perform some functions or services automatically or by request, the electronic device 101 makes a request for performing at least some functions relating thereto to another device 102, 104 or 106 instead of, or in addition to, unilaterally performing the functions or services.

Another electronic device 102, 104 or 106 executes the requested functions or the additional functions, and delivers a result of the execution to the electronic device 101. The electronic device 101 processes the received result as it is or additionally in order to provide the requested functions or services. To this end cloud computing, distributed computing, or client-server computing technology may be used.

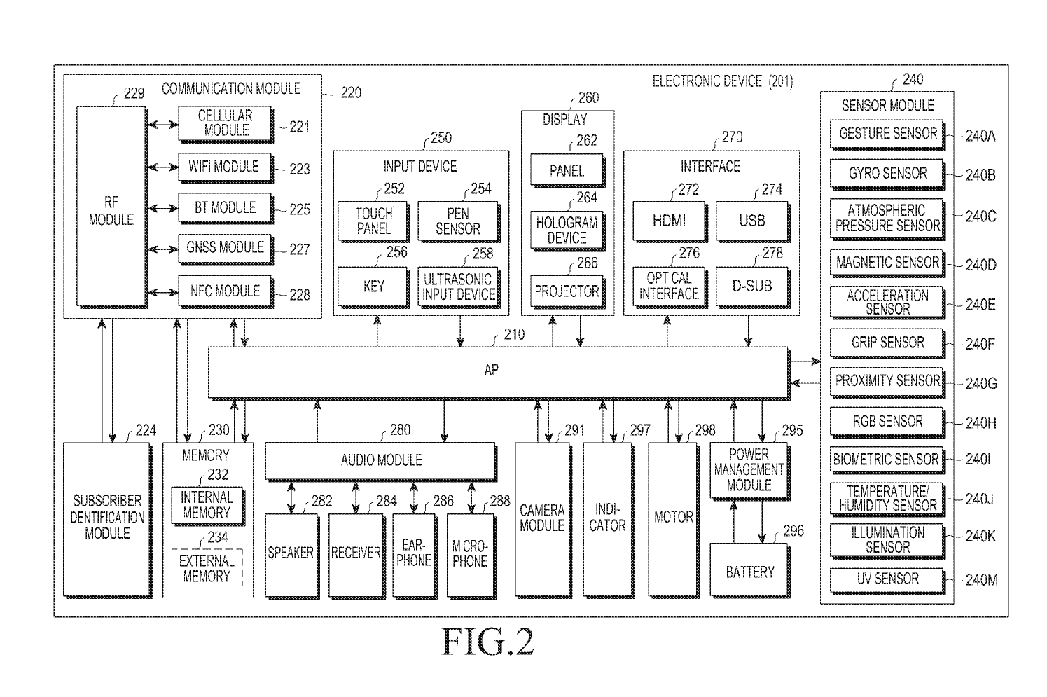

FIG. 2 is a block diagram of an electronic device 201 according to embodiments of the present disclosure. For example, the electronic device 201 includes all or part of the electronic device 101 illustrated in FIG. 1. The electronic device 201 includes at least one application processor (AP) 210, a communication module 220, a subscriber identification module (SIM) card 224, a memory 230, a sensor module 240, an input device 250, a display 260, an interface 270, an audio module 280, a camera module 291, a power management module 295, a battery 296, an indicator 297, and a motor 298.

The processor 210 controls multiple hardware or software elements connected to the processor 210 by running an OS or an application program, and processes various data and execute operations. The processor 210 may be embodied as a system on chip (SoC). According to an embodiment of the present disclosure, the processor 210 may 20 further include a graphic processing unit (GPU) and/or an image signal processor. The processor 210 includes at least some of the components illustrated in FIG. 2. The processor 210 loads, into a volatile memory, instructions or data received from at least one of the other components, processes the loaded instructions or data, and stores various data in a non-volatile memory.

The communication module 220 may have a configuration that is identical or similar to that of the communication interface 170 illustrated in FIG. 1. The communication module 220 includes a cellular module 221, a Wi-Fi module 223, a Bluetooth™ module 225 (BT), a GNSS module 227, an NFC module 228, and a radio frequency (RF) module 229.

The cellular module 221 provides a voice call, an image call, a text message service, and an Internet service, through a communication network, identifies and authenticates the electronic device 201 within a communication network by using the SIM) card 224, performs at least some of the functions that the processor 210 provides, and includes a communication processor (CP).

Each of the Wi-Fi module 223, the BT module 225, the GNSS module 227, and the NFC module 228 includes a processor for processing data that is transmitted and received through a corresponding module. According to some embodiments, at least two of the cellular module 221, the WiFi module 223, the BT module 225, the GNSS module 227, and the NFC module 228 may be included in one integrated chip (IC) or IC package.

The RF module 229 transmits/receives a communication signal, such as an RF signal. The RF module 229 includes a transceiver, a power amp module (PAM), a frequency filter, a low noise amplifier (LNA), and an antenna, for example. According to another embodiment of the present disclosure, at least one of the cellular module 221, the WiFi module 223, the BT module 225, the GNSS module 227, and the NFC module 228 transmits/receives an RF signal through a separate RF module.

The SIM card 224 includes a card containing a subscriber identity module and/or an embedded SIM, and contains unique identification information, such as an integrated circuit card identifier (ICCID) or subscriber information, such as an international mobile subscriber identity (IMSI).

The memory 230 includes an embedded memory 232 or an external memory 234. The embedded memory 232 includes at least one of a volatile memory, such as a dynamic random access memory (DRAM), a static RAM (SRAM), and a synchronous dynamic RAM (SDRAM) and a non-volatile memory, such as a one- time programmable read only memory (OTPROM), a programmable ROM (PROM), an erasable and programmable ROM (EPROM), an electrically erasable and programmable ROM (EEPROM), a mask ROM, a flash ROM, a flash memory, such as a NAND flash memory or a NOR flash memory, a hard driver, or a solid state drive (SSD).

An external memory 234 may further include a flash drive a compact flash (CF), a secure digital (SD), a micro Secure Digital (Micro-SD), a Mini Secure Digital (Mini-SD), an eXtreme digital (xD), a multi-media card (MMC), and a memory stick. The external memory 234 is functionally and/or physically connected to the electronic device 201 through various interfaces.

The sensor module 240 measures a physical quantity or detects an operation state of the electronic device 201, and converts the measured or detected information into an electrical signal. The sensor module 240 includes at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H, such as a red, green, blue (RGB) sensor, a biometric sensor 240I, a temperature/humidity sensor 240J, a light sensor 240K, and a ultraviolet (UV) sensor 240M.

Additionally or alternatively, the sensor module 240 includes an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor module 240 may further include a control circuit for controlling at least one sensor included therein. The electronic device 201 may further include a processor configured to control the sensor module 240 as a part of, or separately from, the processor 210, and to control the sensor module 240 while the processor 210 is in a sleep state.

The input device 250 includes a touch panel 252, a (digital) pen sensor 254, a key 256, or an ultrasonic input unit 258. The touch panel 252 may use at least one of a capacitive type, a resistive type, an infrared type, and an ultrasonic type. The touch panel 252 may further include a control circuit. The touch panel 252 may further include a tactile layer that provides a tactile reaction to a user.

The (digital) pen sensor 254 includes a recognition sheet that is a part of the touch panel or is separated from the touch panel. The key 256 includes a physical button, an optical key or a keypad. The ultrasonic input device 258 detects ultrasonic waves generated by an input tool, through a microphone 288, and determines data corresponding to the detected ultrasonic waves.

The display 260 includes a panel 262, a hologram device 264, or a projector 266. The panel 262 includes a configuration identical or similar to that of the display 160 illustrated in FIG. 1. The panel 262 may be embodied to be flexible, transparent, or wearable. The panel 262 and the touch panel 252 may be embodied as one module. The hologram device 264 indicates a three-dimensional image in the air by using an interference of light. The projector 266 displays an image by projecting light onto a screen that is located inside or outside the electronic device 201. The display 260 may further include a control circuit for controlling the panel 262, the hologram device 264, or the projector 266.

The interface 270 includes a high-definition multimedia interface (HDMI) 272, a universal serial bus (USB) 274, an optical interface 276, or a D-subminiature (D-sub) 278. The interface 270 may be included in the communication interface 170 illustrated in FIG. 1. Additionally or alternatively, the interface 270 includes a mobile high-definition link (MHL) interface, a secure digital (SD) card/multi-media card (MMC) interface, or an infrared data association (IrDA) standard interface.

For example, the audio module 280 bilaterally converts a sound and an electrical signal. At least some components of the audio module 280 may be included in the input/output interface 145 illustrated in FIG. 1. The audio module 280 processes sound information that is input or output through a speaker 282, a receiver 284, earphones 286, or the microphone 288, for example.

The camera module 291 photographs a still image and a dynamic image. According to an embodiment of the present disclosure, the camera module 291 includes one or more image sensors, such as a front sensor or a back sensor, a lens, an image signal processor (ISP), or a flash, such as a light-emitting diode (LED) or a xenon lamp.

The power management module 295 manages the power of the electronic device 201. According to an embodiment of the present disclosure, the power management module 295 includes a power management integrated circuit (PMIC), a charger integrated circuit (IC), or a battery gauge. The PMIC may use a wired and/or wireless charging method. Examples of the wireless charging method include a magnetic resonance, magnetic induction, and electromagnetic method. Additional circuits for wireless charging, such as a coil loop, a resonance circuit, and a rectifier, may be further included. The battery gauge measures a residual quantity of the battery 296, and a voltage, a current, or a temperature during the charging, and includes a rechargeable battery and/or a solar battery.

The indicator 297 displays a particular state, such as a booting, message, or charging state of the electronic device 201 or a part of the electronic device 201. The motor 298 converts an electrical signal into a mechanical vibration, and generates a vibration or a haptic effect. The electronic device 201 includes a graphic processing unit (GPU) for supporting a mobile television (TV) which processes media data according to a certain standard, such as digital multimedia broadcasting (DMB), digital video broadcasting (DVB), or mediaFLO™.

Each of the above-described component elements of hardware according to the present disclosure may be configured with one or more components, and the names of the corresponding component elements may vary based on the type of electronic device. In embodiments, the electronic device includes at least one of the above-described elements. Some of the above-described elements may be omitted from the electronic device, or the electronic device may further include additional elements. Some of the hardware components may be combined into one entity, which performs functions identical to those of the relevant components before the combination.

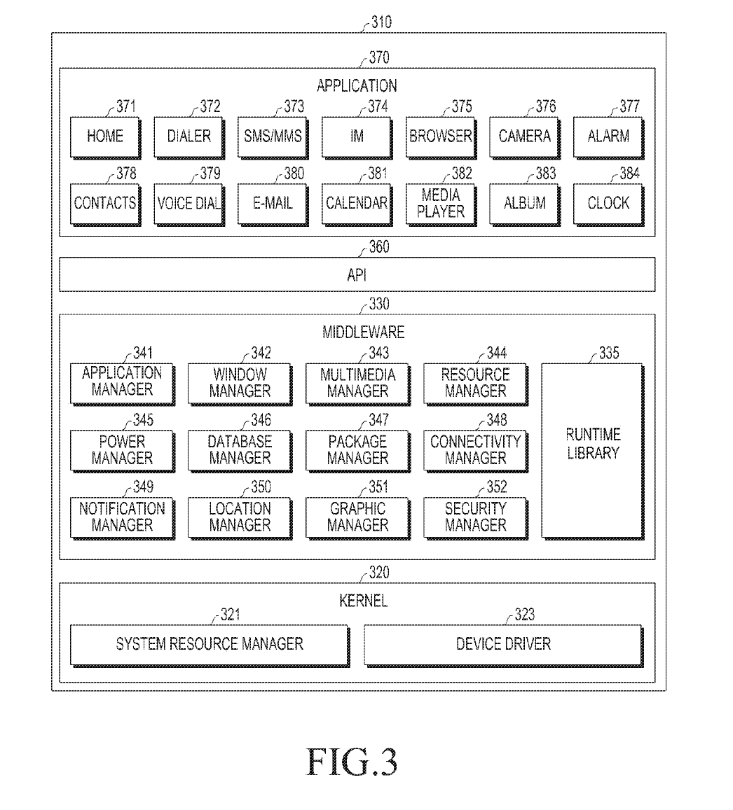

FIG. 3 is a block diagram of a program module according to embodiments of the present disclosure. The program module 310 includes an operating system (OS) for controlling resources related to an electronic device, such as the electronic device 101, and/or various 147 executed in the operating system. The operating system may be Android, iOS, Windows, Symbian, Tizen, or Bada, for example.

The program module 310 includes a kernel 320, middleware 330, an application programming interface (API) 360, and/or applications 370. At least some of the program module 310 may be preloaded on the electronic device, or may be downloaded from an external electronic device.

The kernel 320 includes a system resource manager 321 and/or a device driver 323. The system resource manager 321 performs the control, allocation, and collection of system resources. According to an embodiment of the present disclosure, the system resource manager 321 includes a process management unit, a memory management unit, and a file system management unit. The device driver 323 includes a display driver, a camera driver, a Bluetooth™ driver, a shared memory driver, a USB driver, a keypad driver, a Wi-Fi driver, an audio driver, or an inter-process communication (IPC) driver.

The middleware 330 provides a function required by the applications 370 in common or provides various functions to the applications 370 through the API 360 so that the applications 370 may efficiently use limited system resources within the electronic device. The middleware 330 includes at least one of a runtime library 335, an application manager 341, a window manager 342, a multimedia manager 343, a resource manager 344, a power manager 345, a database manager 346, a package manager 347, a 20 connectivity manager 348, a notification manager 349, a location manager 350, a graphic manager 351, and a security manager 352.

The runtime library 335 includes a library module that a compiler uses in order to add a new function through a programming language while the applications 370 are executed. The runtime library 335 performs input/output management, memory management and a function for an arithmetic function, for example.

The application manager 341 manages a life cycle of at least one of the applications 370. The window manager 342 manages graphical user interface (GUI) resources used for a screen. The multimedia manager 343 determines a format required to reproduce various media files, and may encode or decode a media file by using a coder/decoder (codec) that is appropriate for the corresponding format. The resource manager 344 manages resources, such as a source code, a memory, and a storage space of at least one of the applications 370.

The power manager 345 operates together with a basic input/output system (BIOS) to manage a battery or power, and provides power information required for the operation of an electronic device. The database manager 346 generates, searches for, or changes a database to be used by at least one of the applications 370. The package manager 347 manages the installation or updating of an application distributed in the form of a package file.

The connectivity manager 348 manages a wireless connection Wi-Fi or Bluetooth™. The notification manager 349 displays or reports an event, such as an arrival message, an appointment, or a proximity notification in a manner that does not disturb the user. The location manager 350 manages location information of an electronic device. The graphic manager 351 manages a graphic effect, which is to be provided to the user, or a user interface related to the graphic effect. The security manager 352 provides various security functions required for system security and user authentication. According to an embodiment of the present disclosure, when an electronic device has a telephone call function, the middleware 330 may further include a telephony manager for managing a voice call function or a video call function of the electronic device.

The middleware 330 includes a middleware module that forms a combination of various functions of the above-described components. The middleware 330 provides a module that is specialized for each type of operating system in order to provide a differentiated function. The middleware 330 may dynamically delete some of the existing components, or may add new components.

The API 360, which is a set of API programming functions, may be provided in a different configuration for each operating system. For example, in the case of Android or iOS, one API set may be provided for each platform, and in the case of Tizen, two or more API sets may be provided for each platform.

The applications 370 include one or more applications that are capable of providing functions such as home 371, dialer 372, short message service/multimedia messaging service (SMS/MMS) 373, instant message (IM) 374, browser 375, camera 376, alarm 377, contacts 378, voice dialer 379, e-mail 380, calendar 381, media player 382, album 383, clock 384, health care, such as measuring exercise quantity or blood sugar, and environment information, such as atmospheric pressure, humidity, or temperature information.

According to an embodiment of the present disclosure, the applications 370 include an information exchange application for supporting the exchanging of information between the electronic device and an external electronic device. The information exchange application includes a notification relay application for transferring predetermined information to an external electronic device or a device management application for managing an external electronic device.

For example, the notification relay application includes a function of transferring, to an external electronic device, notification information generated from other applications of the electronic device 101. The notification relay application receives notification information from an external electronic device and provides the received notification information to a user.

The device management application installs, deletes, or updates at least a function of an external electronic device 102, 104 communicating with an electronic device, applications executed in the external electronic device, or services provided from the external electronic device, such as a phone call or message service.

According to an embodiment of the present disclosure, the applications 370 include a health care application of a mobile medical appliance designated based on a property of an external electronic device 102 or 104. According to an embodiment of the present disclosure, the applications 370 include an application received from an external electronic device. According to an embodiment of the present disclosure, the applications 370 include a preloaded application or a third party application that can be downloaded from a server. The names of the components of the program module 310 according to the illustrated embodiment may vary according to the type of operating system.

According to embodiments, at least a part of the programming module 310 may be implemented in software, firmware, hardware, or a combination of two or more thereof. At least some of the program module 310 may be executed by the processor. At least a part of the program module 310 includes a module, a program, a routine, a set of instructions, and/or a process for performing one or more functions.

The term “module” as used herein may indicate a unit including one or a combination of at least two of hardware, software, and firmware. The “module” may be interchangeably used with the terms “unit”, “logic”, “logical block”, “component”, or “circuit”. The “module” may be a minimum unit of an integrated component element or a part thereof, may be a minimum unit for performing one or more functions or a part thereof, and may be mechanically or electronically implemented. For example, the “module” according to the present disclosure includes at least one of an application-specific integrated circuit (ASIC) chip, a field-programmable gate array (FPGA), and a programmable-logic device for performing operations which has been known or are to be developed hereinafter.

At least some of the devices or the method according to the present disclosure may be implemented by a command stored in a computer-readable storage medium in a programming module form. The instruction, when executed by a processor 120, may cause the one or more processors to execute the function corresponding to the instruction. The computer-readable storage medium may be the memory 130.

The computer readable recoding medium includes a hard disk, a floppy disk, magnetic media, such as a magnetic tape, optical media, such as a compact disc read only memory (CD-ROM) and a digital versatile disc (DVD), magneto-optical media, such as a floptical disk, a hardware device, such as a ROM, a random access memory (RAM), and a flash memory. In addition, the program instructions include high class language codes, which can be executed in a computer by using an interpreter, as well as machine codes made by a compiler. The aforementioned hardware device may be configured to operate as one or more software modules in order to perform the operation of the present disclosure, and vice versa.

Any of the modules or programming modules according to embodiments of the present disclosure may include at least one of the above described elements, exclude some of the elements, or further include other additional elements. The operations performed by the modules, programming module, or other elements according to embodiments of the present disclosure may be executed in a sequential, parallel, repetitive, or heuristic manner. Some operations may be executed according to another order or may be omitted, or other operations may be added.

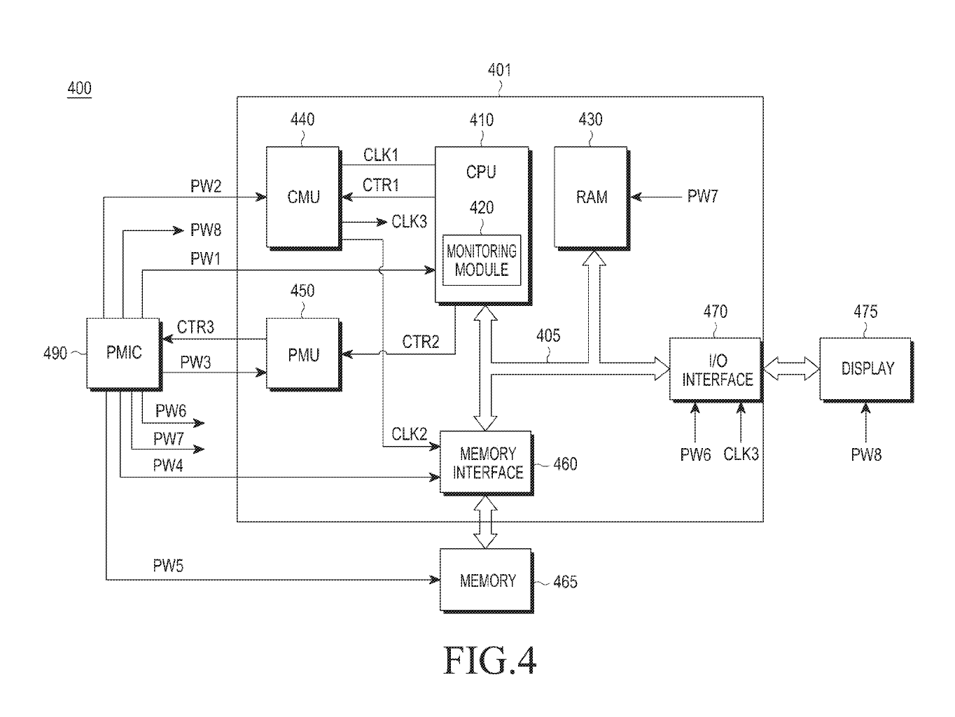

FIG. 4 schematically illustrates an electronic device according to an embodiment of the present disclosure.

Referring to FIG. 4, an electronic device 400 includes a controller 401, a memory 465, a display 475, and a PMIC 490.

For example, the electronic device 400 may be a personal computer (PC), a mobile computing device, a smart phone, or a wearable device.

The controller 401 controls the operations of the PMIC 490 and the memory 465. The controller 401 may be embodied as a host, an IC, a motherboard, a system on chip (SoC), an AP, or a mobile AP.

The controller 401 may be embodied to be substantially the same as, or similar to, the processor 120 as illustrated in FIG. 1.

For example, when the controller 401 is embodied as a first package that includes an SoC, an AP, or a mobile AP, and the memory 465 is embodied as a second package, the second package may be layered over the first package through stack balls.

The controller 401 includes a bus architecture 405, a central processing unit (CPU) 410, an embedded memory 430, a clock management unit (CMU) 440, a power management unit (PMU) 450, a memory interface 460, and an input/output interface 470.

The bus architecture 405 may be embodied as an advanced microcontroller bus architecture (AMBA), an advanced high-performance bus (AHB), an advanced peripheral bus (APB), an advanced extensible interface (AXI), an AXI coherency extension (ACE), an advanced system bus (ASB), or a combination thereof, but the present disclosure is not be limited thereto.

The CPU 410 executes the monitoring module 420 according to an embodiment of the present disclosure. A clock (or clock frequency) management method, which is controlled by the monitoring module 420 that is executed by a master such as the CPU 410, may be applied to the controller 401.

The CPU 410 includes a GPU, which may be included in the controller 401, separately from the CPU 410.

The CPU 410 and the GPU include multi-processors such as a plurality of processors or cores. For example, each of the CPU 410 and the GPU includes a plurality of processors such as a dual-core or quad-core processor.

The monitoring module 420 is a program or a firmware that is executed in the CPU 410, and monitors screen updating for each of the frames included in image data that is displayed in the display 475.

The monitoring module 420 generates a control signal that controls the frequency and power of the controller 401, based on a result of monitoring. For example, the monitoring module 420 executed by the CPU 410 generates control signals that provide power and/or a frequency with respect to each of the CPU 410, the memory interface 460, and the input/output interface 470. The monitoring module 420 controls a voltage and a frequency with respect to each of the CPU 410, the memory interface 460, and the input/output interface 470, based on dynamic voltage and frequency scaling (DVFS).

According to an embodiment of the present disclosure, the monitoring module 420 monitors a time associated with screen updating, and generates a control signal that controls a driving frequency and/or a voltage based on a result of monitoring. For example, the monitoring module 420 measures a time associated with screen updating, compares the measured time and a reference time that is set in advance, and generates a control signal that controls a driving frequency and/or a supply voltage based on a comparison result. The monitoring module 420 measures a frame rate, such as frame per second (FPS) corresponding to screen updating, compares the measured time and an FPS that is set in advance, and generates a control signal that controls a driving frequency and/or a supply voltage based on a comparison result.

For example, the monitoring module 420 may be embodied as a Surface Flinger in the Android OS.

Image data indicates an image, a picture, a user interface (UI), user experience (UX), and/or image frame visual information or data.

According to an embodiment of the present disclosure, the image data includes a plurality of frames that are disposed at regular intervals.

Screen updating indicates an operation that outputs the frames included in the image data at regular intervals, so that a user may visually recognize image data or video without disconnection.

A time associated with screen updating indicates a time interval between the frames included in image data. For example, the screen updating time indicates a drawing time of a frame corresponding to screen updating. The screen updating time indicates a frame rate or an FPS in association with the frames included in image data.

According to an embodiment of the present disclosure, the screen updating time indicates a time from the drawing start time to the drawing complete time of a frame corresponding to screen updating.

The reference time that is set in advance indicates a reference value in association with a screen updating time, which is set based on an electronic device or a processor included in the electronic device so as to enable a user to visually recognize image data or video without disconnection. For example, the screen updating time indicates a reference value in association with the drawing time of a frame corresponding to screen updating. The reference time or frame rate set in advance indicates a reference value in association with a frame rate or an FPS of the frames included in image data.

According to an embodiment of the present disclosure, a reference time set in advance may be determined by a program based on an electronic device or a processor, or may be set in advance by a user.

The CMU 440 adjusts a first frequency of a first clock signal (CLK1) supplied to the CPU 410, a second frequency of a second clock signal (CLK2) supplied to the memory interface 460, and/or a third frequency of a third clock signal (CLK3) supplied to the input/output interface 470, in response to a first control signal (CTR1) that is output from the CPU 410 or the monitoring module 420 executed by the CPU 410. The adjustment indicates ‘increase’, ‘maintain’, or ‘decrease’.

The PMU 450 generates a third control signal (CTR3) that controls the operations of the PMIC 490, in response to a second control signal (CTR2) that is output from the CPU 410 or the monitoring module 420 that is executed by the CPU 410.

The memory interface 460 controls a write-operation or a read-operation in association with the memory 465, under the control of the CPU 410, based on a second frequency of the CLK2 that is output from the CMU 440 and a level of a fourth working voltage (PW4) that is output from the PMIC 490. Each of the second frequency of the CLK2 and the level of PW4 may be adjusted based on a DVFS.

Although FIG. 4 illustrates the single memory interface 460 and the single memory 465, the memory interface 460 may include a plurality of different memory interfaces, and the memory 465 may include different memories.

For example, when the memory 465 is a set that includes a dynamic RAM (DRAM) and a flash memory, such as an NAND-type or NOR-type flash memory, the memory interface 460 may be a set that includes a DRAM controller and a flash memory controller, but the present disclosure is not limited thereto.

According to an embodiment of the present disclosure, the memory 465 may be embodied as a solid state drive or solid state disk (SSD), an embedded SSD (eSSD), a multimedia card (MMC), an embedded MMC (eMMC), or a universal flash storage (UFS), but the present disclosure is not limited thereto.

The PMIC 490 adjusts a level of each working voltage (PW1 to PW8), in response to CTR3. For example, in response to CTR3, the PMIC 490 controls the level of the first working voltage (PW1) supplied to the CPU 410, the second working voltage (PW2) supplied to the CMU 440, the third working voltage (PW3) supplied to the PMU 450, the fourth working voltage (PW4) supplied to the memory interface 460, the fifth working voltage (PW5) supplied to the memory 465, the sixth working voltage (PW6) supplied to the input/output interface 470, the seventh working voltage (PW7) supplied to the embedded memory 430, and the eighth working voltage (PW8) supplied to the display 475. However, the present disclosure is not limited thereto.

According to an embodiment of the present disclosure, each control signal (CTR2, CTR2, and CTR3) includes at least one analog signal or at least one digital signal.

The input/output interface 470 is used for inputting and outputting data, and transmits or receives data based on CLK3 that is output from the CMU 440 or PW6 that is output from the PMIC 490. Each of CLK3 and the level of PW6 may be adjusted based on a DVFS.

According to an embodiment of the present disclosure, the input/output interface 470 may be embodied as an interface that may support a serial advanced technology attachment (SATA), a SATA express (SATAe), a serial attached small computer system interface (SCSI) (SAS), a peripheral component interconnect express (PCIe) or a mobile industry processor interface (MIPI), but the present disclosure is not limited thereto.

The input/output interface 470 controls a display-operation in association with the display 475, under the control of the CPU 410. The input/output interface 470 controls image data outputting in association with the display 475, based on the third frequency of CLK3 that is output from the CMU 440 and the level of PW6 that is output from the PMIC 490. Each of the third frequency of CLK3 and the level of the sixth working voltage (PW6) may be adjusted based on a DVFS.

Although FIG. 4 illustrates the single input/output interface 470 and the single display 475, the input/output interface 470 is set including a plurality of different input/output interfaces, and the display 475 includes different input/output devices.

The embedded memory 430 may be a working memory of the CPU 410. For example, the embedded memory 430 may be a ROM or an SRAM, but the present disclosure is not limited thereto. For example, when the memory 465 is embodied as a non-volatile memory and the electronic device 400 is booted up, the monitoring module 420 stored in the memory 465 may be loaded to the embedded memory 430, and may be executed by the CPU 410.

According to an embodiment of the present disclosure, the embedded memory 430 may be embodied as a frame buffer of the CPU 410 or the monitoring module 420. For example, when the CPU 410 displays image data in the display 475, the embedded memory 430 may act as a frame buffer and store the image data.

The controller 401 may embody the memory 465 as a frame buffer. For example, when the CPU 410 displays image data in the display 475, the memory 465 serves as a frame buffer and stores the image data .

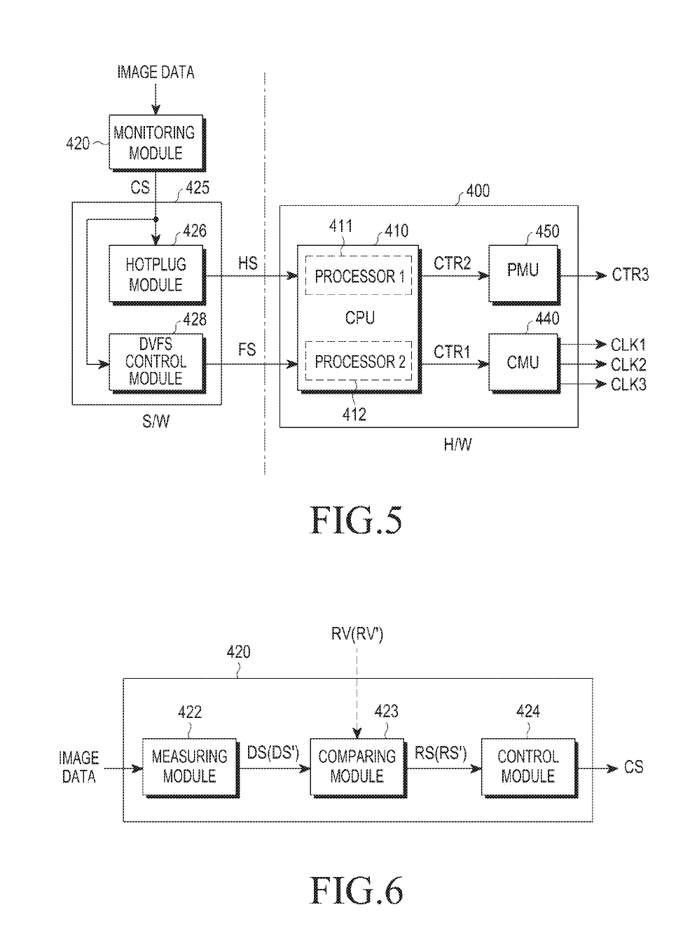

FIG. 5 illustrates a method of controlling a time associated with screen updating.

Referring to FIGS. 4 and 5, the CPU 410 includes the monitoring module 420 and a booster module 425 .

The monitoring module 420 monitors a screen updating time with respect to the frames included in image data. The monitoring module 420 generates a control signal (CS), and transmits the generated CS to the booster module 425, based on a result of monitoring.

According to an embodiment of the present disclosure, the monitoring module 420 monitors whether a screen updating time is delayed. For example, the monitoring module 420 measures a screen updating time and compares the measured time and a reference time that is set in advance in association with the screen updating time. The monitoring module 420 measures an FPS corresponding to the screen updating time, and compares the measured frame rate and a frame rate set in advance.

When a comparison result indicates that the measured time is greater than the reference time, the monitoring module 420 generates the CS, and transmits the generated CS to the booster module 425. For example, based on the comparison result, the monitoring module 420 transmits the CS to a hot-plug module 426 and a DVFS control module 428.

When the comparison result indicates that the measured FPS is less than the reference FPS, the monitoring module 420 generates the CS, and transmits the generated CS to the booster module 425. For example, based on the comparison result, the monitoring module 420 transmits the CS to the hot-plug module 426 and the DVFS control module 428.

The booster module 425 includes the hot-plug module 426 and the DVFS control module 428.

The booster module 425 controls the CPU 410 in response to the CS that is received from the monitoring module 420. For example, the booster module 425 controls the CPU 410 to increase a driving frequency of the electronic device 400, in response to the CS.

Although FIG. 5 illustrates that the booster module 425 includes only the hot-plug module 426 and the DVFS control module 428, the present disclosure is not limited thereto, and the booster module 425 may further include a module that executes another function that enables the CPU 410 to increase a driving frequency.

The CS indicates a signal that is provided from the monitoring module 420 and controls the CPU 410, so as to prevent screen disconnection or deterioration in FPS in association with image data. For example, when the CPU 410 corresponds to multi-processors, the CS controls the hot-plug module 426 to enable a plurality of processors or cores included in the CPU 410 to operate. The CS controls the DVFS control module 428 to increase a driving frequency and/or a driving voltage.

When the CPU 410 corresponds to multi-processors, the hot-plug module 426 controls whether to operate the multi-processors in response to the CS.

The hot-plug module 426 generates a hot-plug control signal (HS) that controls whether to operate each multi-processor, and transmits the HS to the CPU 410.

DVFS control module 428 controls a DVFS, such as a supply frequency and a supply voltage, in association with an electronic device, based on the CS. According to an embodiment of the present disclosure, the DVFS control module 428 controls a DVFS, such as a supply frequency and a supply voltage in association with the CPU 410, based on the CS. The DVFS control module 428 controls a DVFS in association with each of the memory interface 460 and the input/output interface 470, based on the CS.

The DVFS control module 428 generates a DVFS control signal (FS) for the CPU 410, the memory interface 460, and/or the input/output interface 470, and transmits the FS to the CPU 410.

Although FIG. 5 illustrates that the CPU 410 executes all of the monitoring module 420, the hot-plug module 426, and the DVFS control module 428, the present disclosure is not limited thereto, and the CPU 410 may be embodied to include at last one of the monitoring module 420, the hot-plug module 426, and the DVFS control module 428.

The CPU 410 controls the PMU 450 and the CMU 440, in response to control signals (HS and FS) that are received from the booster module 425. For example, the CPU 410 transmits a first control signal (CRT1) to the CMU 440, and transmits a second control signal (CRT2) to the PMU 450 in response to the control signals (HS and FS).

The CMU 440 controls the clock signals (CLK1, CLK2, and/or CLK3) of a frequency supplied to the CPU 410, the memory interface 460, and/or the input/output interface 470, in response to CTR1. The PMU 450 controls power supplied to the electronic device 400, and transmits CTR3 to the PMIC 490 in response to CTR1.

FIG. 6 illustrates a method of monitoring a time associated with screen updating, according to an embodiment of the present disclosure.

Referring to FIGS. 4 to 6, the monitoring module 420 includes a measuring module 422, a comparing module 423, and a control module 424.

The measuring module 422 monitors a screen updating time with respect to each of the frames included in the image data.

According to an embodiment of the present disclosure, the measuring module 422 measures a screen updating time and/or a frame rate with respect to the frames of the image data in real time or periodically.

According to an embodiment of the present disclosure, the measuring module 422 measures a screen updating time, and transmits the measured time (DS) to the comparing module 423 and a measured frame rate (DS′) to the comparing module 423.

The comparing module 423 compares the DS and a reference time (RV) associated with screen updating, and transmits a comparison result (RS) to the control module 424. The comparing module 423 also compares DS′ and a reference frame rate (RV′) associated with screen updating, and transmits a comparison result (RS′) to the control module 424.

According to an embodiment of the present disclosure, the comparing module 423 compares RV associated with screen updating and DS. The comparing module 423 compares RV′ associated with screen updating and DS′.

The comparing module 423 receives RV associated with screen updating from the embedded memory 430 or the memory 465. The comparing module 423 receives RV′ associated with screen updating, from the embedded memory 430 or the memory 465.

The comparing module 423 transmits RS and RS′ to the control module 424.

The control module 424 receives RS and/or RS′, and generates a CS based on RS and/or RS′. The control module 424 transmits the CS to the booster module 425 based on RS and/or RS′.

According to an embodiment of the present disclosure, when the RS indicates that a measured time is greater than a reference time, the control module 424 generates the CS, and transmits the generated CS to the booster module 425. When RS′ indicates that DS′ is less than RV′, the control module 424 generates the CS, and transmits the generated CS to the booster module 425.

According to another embodiment of the present disclosure, when RS and/or RS′ indicates that a difference dramatically increases when compared to a comparison result associated with previous screen updating, the control module 424 generates the CS, and transmits the generated CS to the booster module 425.

When RS indicates that a measured time is less than a reference time, the control module 424 may not separately generate the CS. When RS′ indicates that DS′ is greater than RV′, the control module 424 does not separately generate the CS.

Although RS indicates that a measured time is less than a reference time, the control module 424 generates the CS. Although RS′ indicates that DS′ is greater than RV′, the control module 424 generates the CS.

An electronic device includes a first processor that monitors whether screen updating is delayed based on a reference time associated with screen updating, and generates a control signal that controls a screen updating time based on a result of monitoring, and a clock managing unit that controls a clock that is supplied to the electronic device in response to the control signal.

The first processor measures the screen updating time in real time, and compares the measured time and the reference time so as to determine whether the screen updating is delayed.

The control signal controls the clock managing unit so as to increase a clock frequency supplied to the first processor to a predetermined frequency.

The first processor monitors whether the screen updating is delayed based on a frame rate corresponding to the screen updating, and generates the control signal to increase the frame rate based on a result of monitoring.

The first processor executes a monitoring module that monitors whether the screen updating is delayed, and the monitoring module includes a measuring module that measures the screen updating time, a comparing module that compares the reference time and the measured time, and a control module that generates the control signal to control the clock based on a result of the comparison.

The clock managing unit controls a clock that is supplied to at least one of the first processor, a memory interface, and an input/output interface of the electronic device in response to the control signal.

The electronic device further includes a power managing unit that controls power supplied to the first processor in response to the control signal.

The control signal controls the power managing unit to increase power supplied to the first processor to a predetermined voltage.

The electronic device further includes a second processor, and the first processor monitors whether the screen updating is delayed, and determines whether to operate the second processor based on a result of monitoring.

The first processor executes a monitoring module that monitors whether the screen updating is delayed, and the monitoring module includes a measuring module that measures the screen updating time, a comparing module that compares the reference time and the measured time, and a control module that determines whether to operate the second processor based on a result of the comparison.

The screen updating time is from the drawing start point of a frame corresponding to the screen updating to the drawing end point of the frame.

The reference time may be set by a user or a program, based on the first processor.

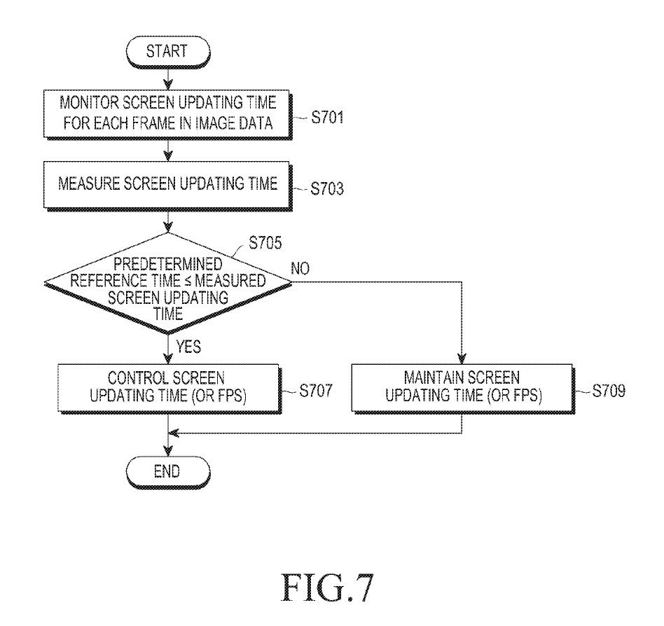

FIG. 7 illustrates an operation method of an electronic device according to an 10 embodiment of the present disclosure.

Referring to FIGS. 4 to 7, when drawing the frames included image data begins, the monitoring module 420 monitors a drawing time with respect to each of the frames in step S701. For example, the monitoring module 420 monitors screen updating corresponding to each frame.

The monitoring module 420 measures a screen updating time corresponding to each of the frames included in the image data in step S703. For example, the monitoring module 420 measures an updating time corresponding to a frame, and generates a DS. The measuring module 420 measures an FPS with respect to the frames of the image data.

The monitoring module 420 compares an RV set in advance in association with screen updating and the DS in step S705. The monitoring module 420 compares RV′ set in advance in association with screen updating and DS′.

When DS is greater than or equal to RV (YES in step S705), the monitoring module 420 controls the screen updating time in step S707.

For example, when DS is greater than RV, the monitoring module 420 determines that screen updating is delayed. In this instance, the monitoring module 420 controls the CPU 410 to decrease the screen updating time.

When DS′ is less than RV′, the monitoring module 420 determines that screen updating is delayed. In this instance, the monitoring module 420 controls the CPU 410 to decrease the screen updating time, to increase the frame rate.

When DS is less than RV (NO in step S705), the monitoring module 420 maintains the screen updating time in step S709, and may not additionally control the screen updating time.

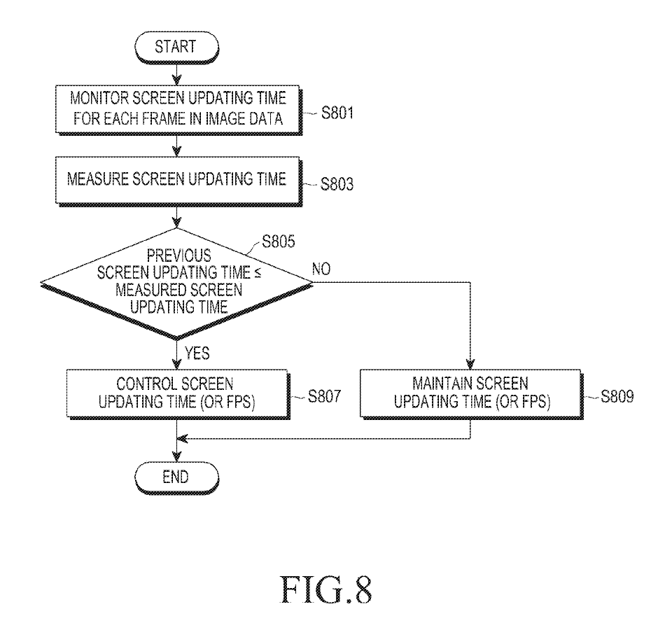

FIG. 8 illustrates an operation method of an electronic device according to another embodiment of the present disclosure.

Referring to FIGS. 4 to 8, when drawing the frames included in the image data begins, the monitoring module 420 monitors a drawing time with respect to each of the frames in step S801. For example, the monitoring module 420 monitors screen updating corresponding to each frame.

The monitoring module 420 measures a screen updating time corresponding to each of the frames included in image data in step S803. For example, the monitoring module 420 measures an updating time corresponding to a frame, and generates DS. The measuring module 420 measures a frame rate (or FPS) with respect to the frames of the image data.

The monitoring module 420 sets a reference time (RV) based on a previous screen updating time, and sets RV′ based on a frame rate corresponding to previous screen updating.

According to an embodiment of the present disclosure, the monitoring module 420 compares the RV set based on the previous screen updating time and DS, in step S805. The monitoring module 420 compares RV′ in association with screen updating and DS′.

When DS is greater than or equal to RV set based on the previous screen updating time (YES in step S805), the monitoring module 420 controls the screen updating time in step S807.), For example, when DS is dramatically different when compared to the previous screen updating time, the monitoring module 420 controls the screen updating time.

According to an embodiment of the present disclosure, when DS is greater than RV set based on the previous screen updating time, the monitoring module 420 determines that screen updating is delayed. In this instance, the monitoring module 420 controls the CPU 410 to decrease the screen updating time.

When DS′ is less than RV′ set based on the previous screen updating time, the monitoring module 420 determines that screen updating is delayed. In this instance, the monitoring module 420 controls the CPU 410 to decrease the screen updating time, such as to increase the frame rate.

When DS is less than RV set based on the previous screen updating time (NO in step S805), the monitoring module 420 maintains the screen updating time in step S809, and may not additionally control the screen updating time.

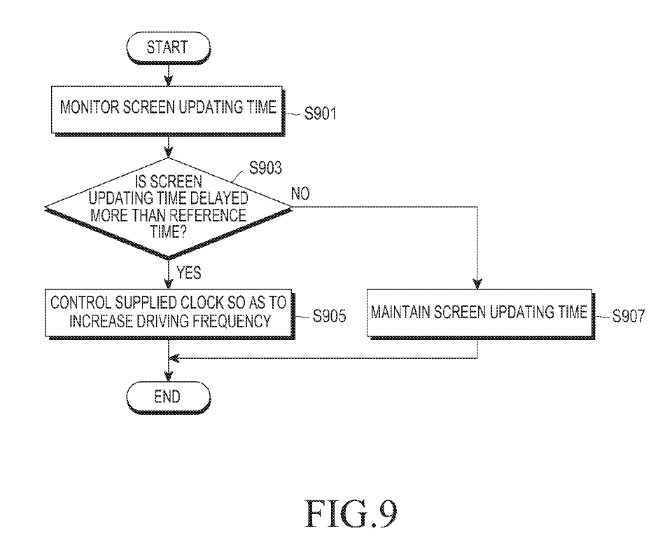

FIG. 9 illustrates an operation method of a monitoring module according to an embodiment of the present disclosure.

Referring to FIGS. 4 to 9, the monitoring module 420 monitors a screen updating time with respect to each of the frames of image data in step S901.

The monitoring module 420 determines whether a screen updating time with respect to a frame is delayed based on an RV in step S903. In this instance, the methods described through FIGS. 7 and 8 may be used for the monitoring module 420 to determine whether the screen updating time is delayed.

When the screen updating time is delayed more than RV (YES in step S903), the monitoring module 420 controls a clock supplied to the CPU 410 so as to increase a driving frequency of the CPU 410, in step S905. For example, the monitoring module 420 controls a clock (CLK1 to CLK3) supplied to at least one of the devices included in the electronic device 400, so as to increase a driving frequency of at least one of the devices included in the electronic device.

When the screen updating time is not delayed more than RV (NO in step S903), the monitoring module 420 maintains the screen updating time in step S907. For example, the monitoring module 420 controls the CPU 410 to maintain a supply frequency.

When the screen updating time is not delayed or is delayed less than RV (NO in step S903), the monitoring module 420 may not additionally control the screen updating time. For example, the monitoring module 420 may not additionally control the driving frequency.

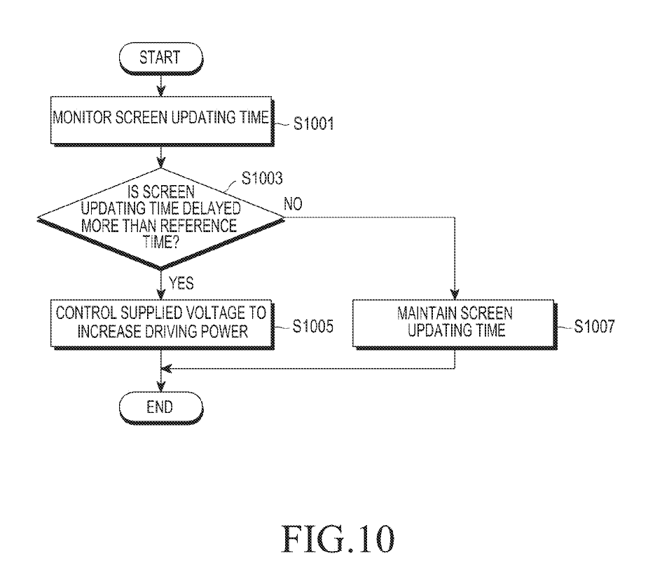

FIG. 10 illustrates an operation method of a monitoring module according to another embodiment of the present disclosure.

Referring to FIGS. 4 to 10, the monitoring module 420 monitors a screen updating time with respect to each of the frames of image data in step S1001.

The monitoring module 420 determines whether a screen updating time with respect to a frame is delayed based on an RV in step S1003. In this instance, the methods described through FIGS. 7 and 8 may be used for the monitoring module 420 to determine whether the screen updating time is delayed.

When the screen updating time is delayed more than RV (YES in step S1003), the monitoring module 420 controls a voltage or a current supplied to the CPU 410 so as to increase a driving frequency of the CPU 410, in step S1005. For example, the monitoring module 420 controls a voltage (PW1 to PW8) supplied to at least one of the devices included in the electronic device 400, so as to increase the driving power of at least one of the devices included in the electronic device 400.

When the screen updating time is not delayed or is delayed less than RV (NO in step S1003), the monitoring module 420 maintains the screen updating time in step S1007. For example, the monitoring module 420 controls the CPU 410 to maintain a supply voltage or a supply current.

When the screen updating time is not delayed or is delayed less than RV (NO in step S1003), the monitoring module 420 may not additionally control the screen updating time. For example, the monitoring module 420 may not additionally control the supply voltage or the supply current.

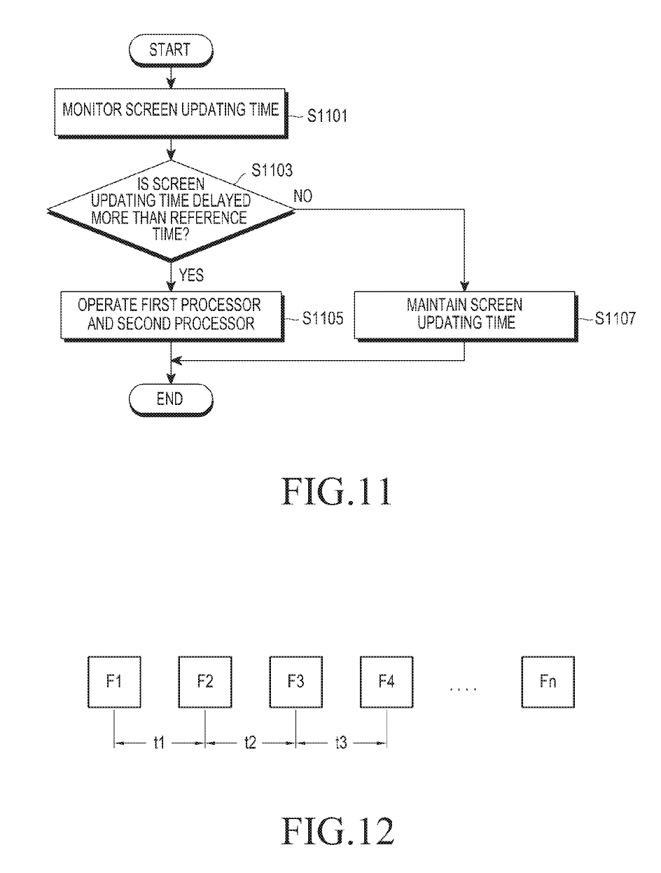

FIG. 11 illustrates an operation method of a monitoring module according to another embodiment of the present disclosure.

Referring to FIGS. 4 to 11, the monitoring module 420 monitors a screen updating time with respect to each of the frames of image data in step S1101.

The monitoring module 420 determines whether a screen updating time with respect to a frame is delayed based on an RV in step S1103. In this instance, the methods described through FIGS. 7 and 8 may be used for the monitoring module 420 to determine whether the screen updating time is delayed more than RV.

When the screen updating time is delayed more than RV (YES in step S1103), the monitoring module 420 controls the operation of each of the multi-processors when the CPU 410 corresponds to multi-processors in step S1105. For example, the monitoring module 420 controls the operation of at least one of the first processor 411 and the second processor 411 included in the CPU 410 through the hot-plug module 426. For example, the monitoring module 420 operates both the first processor 411 and the second processor 412 when the screen updating time is delayed.

When the screen updating time is not delayed or is delayed than RV (NO in step S1103), the monitoring module 420 maintains the screen updating time in step S1107. For example, the monitoring module 420 controls the CPU 410 so as to maintain the operation of each of the multi-processors included in the CPU 410.

When the screen updating time is not delayed or is delayed than RV (NO in step S1103), the monitoring module 420 may not additionally control the screen updating time. For example, the monitoring module 420 may not additionally control the operation of each of the multi-processors included in the CPU 410.

A method of an electronic device includes measuring a screen updating time, and monitoring whether screen updating is delayed based on a reference time associated with the screen updating and the measured time; and controlling a clock supplied to the electronic device, so as to control the screen updating time based on a result of monitoring.

Monitoring whether the screen updating is delayed, includes measuring the screen updating time in real time, and comparing the measured time and the reference time so as to determine whether the screen updating is delayed.

The clock is controlled to increase, to a predetermined frequency, a clock frequency supplied to a processor that controls the screen updating time.

Measuring the screen updating time includes measuring a time from a drawing start point of a frame corresponding to the screen updating to a drawing end point of the frame.

The clock is further controlled to increase a frame rate associated with screen updating based on a result of monitoring.

The method may further include controlling power supplied to a processor that controls the screen updating time, based on a result of monitoring.

The power is further controlled to increase a voltage supplied to the processor, to a predetermined voltage.

The reference time is set by a user or a program, based on a processor included in the electronic device.

The clock supplied to the electronic device is controlled by controlling the clock supplied to at least one of the processor, a memory interface, and an input/output interface of the electronic device.

FIG. 12 illustrates screen updating with respect to each of the frames included in image data according to an embodiment of the present disclosure.

Referring to FIGS. 4 to 12, the image data includes a plurality of frames F1 to Fn, where n is a natural number greater than or equal to 2.

The image data needs to be output at a regular frame rate so that a user visually recognizes the image data without disconnection. In this instance, the frame rate is determined to be an appropriate value that enables a user to visually recognize frames without disconnection, based on an electronic device and/or the CPU 410. For example, the frame rate may be embodied as 24 fps (frames per second), 30 fps, or 60 fps.

The monitoring module 420 measures a screen updating time with respect to each of the frames included in the image data. For example, the monitoring module 420 measures a screen updating time (t1) between a first frame (F1) and a second frame (F2), measures a screen updating time (t2) between F2 and a third frame (F3), and measures a screen updating time (t3) between F3 and a fourth frame (F4).

The monitoring module 420 measures the screen updating time (t1 to t3), compares the measured time (t1 to t3) and RV, and determines whether screen updating is delayed based on a result of the comparison.

For example, when it is determined that t2 between F2 and F3 is delayed, the monitoring module 420 controls a clock to increase a supply frequency of the CPU 410.

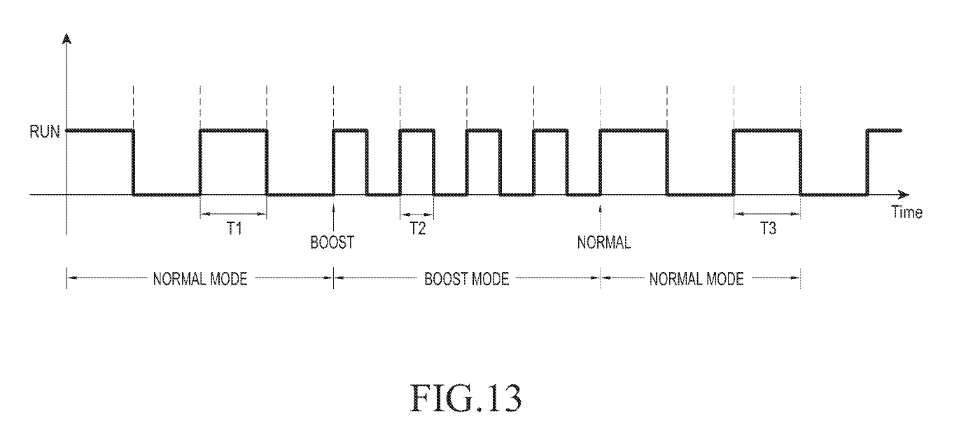

FIG. 13 illustrates a change in a clock frequency by a monitoring module according to an embodiment of the present disclosure.

Referring to FIGS. 4 to 13, when it is determined that screen updating is delayed, the monitoring module 420 controls the CPU 410 through the booster module 425. Under the control of the booster module 425, the CPU 410 controls a clock supplied to the electronic device 400 through the clock managing unit 440.

According to an embodiment of the present disclosure, the CPU 410 controls a clock through the clock managing unit 440, under the control of the monitoring module 420. For example, the CPU 410 controls a clock based on a normal mode and a boost mode under the control of the monitoring module 420.

The normal mode indicates when the monitoring module 420 does not separately control a clock with respect to screen updating. In the normal mode, the CPU 410 generates a clock signal through the CMU 440, based on a first period (T1) or a third period (T3).

The boost mode indicates when the monitoring module 420 controls a clock to increase a driving frequency when it is determined that screen updating is delayed. In the boost mode, the CPU 410 generates a clock signal through the CMU 440, based on a second period (T2).

For example, T1 and T3 may be greater than T2, and T1 and T3 may be equal to or different from each other.

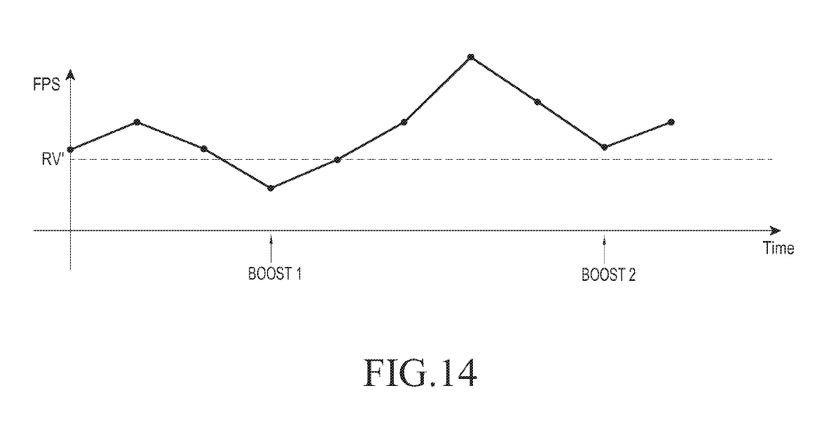

FIG. 14 illustrates a change in an FPS by a monitoring module according to an embodiment of the present disclosure.

Referring to FIGS. 4 to 14, when it is determined that screen updating is delayed, the monitoring module 420 controls the CPU 410 through the booster module 425. Under the control of the booster module 425, the CPU 410 controls an FPS.

According to an embodiment of the present disclosure, the CPU 410 controls an FPS, under the control of the monitoring module 420. For example, the monitoring module 420 measures a frame rate with respect to screen updating, and transmits the CS to the booster module 425 to increase the frame rate based on a result of measuring.

The monitoring module 420 measures a frame rate with respect to the frames included in the image data. The graph illustrated in FIG. 14 indicates a frame rate with respect to the frames included in the image data, which is measured by the monitoring module 420.

The monitoring module 420 compares DS′ in association with screen updating and RV′.

When DS′ is greater than RV′, the monitoring module 420 may maintain the frame rate, or may not additionally control the frame rate.

When DS′ is less than RV′, the monitoring module 420 determines that screen updating is delayed. In this instance, the monitoring module 420 controls the booster module 425 to increase the frame rate.

According to an embodiment of the present disclosure, when DS′ is less than the RV′, the monitoring module 420 may increase the frame rate through a first boost operation (BOOST1).

For example, BOOST1 indicates an operation of the monitoring module 420 to increase a driving frequency, so as to prevent the delay of screen updating when DS′ measured by the monitoring module 420 is less than RV′.

According to BOOST1 of the monitoring module 420, the frame rate with respect to each of the frames of the image data may be increased.

According to another embodiment of the present disclosure, the monitoring module 420 determines whether screen updating is delayed based on a previously measured frame rate. The monitoring module 420 sets RV′ based on the previously measured frame rate.

The monitoring module 420 determines whether screen updating is delayed based on the previously measured frame rate. For example, when a currently measured frame rate is dramatically decreased when compared to the previously measured frame rates(for example, when the measured frame rate has decreased more than or equal to the predetermined value compared to the previously measured frame rates), the monitoring module 420 determines that screen updating is delayed or to be delayed. In this instance, the monitoring module 420 controls the booster module 425 to increase the frame rate.

According to an embodiment of the present disclosure, when DS′ is significantly less than the previously measured frame rate(for example, when DS′ is greater than or equal to the difference of predetermined value compared to the previously measured frame rate), the monitoring module 420 may increase the frame rate through a second boost operation (BOOST2).

For example, BOOST2 indicates an operation of the monitoring module 420 to increase a driving frequency, so as to prevent the delay of screen updating when DS′ measured by the monitoring module 420 is significantly less than the previously measured frame rates.

According to BOOST2 of the monitoring module 420, the frame rate with respect to each of the frames of the image data may be increased.

Each of the components of the electronic device according to the present disclosure may be implemented by one or more components and the name of the corresponding component may vary depending on a type of the electronic device. In embodiments, the electronic device includes at least one of the above-described elements. Some of the above-described elements may be omitted from the electronic device, or the electronic device may include additional elements. Some of the components of the electronic device according to the embodiments of the present disclosure may be combined to form a single entity, and thus, may equivalently execute functions of the corresponding elements prior to the combination.

The embodiments disclosed herein are provided merely to easily describe technical details of the present disclosure and to help the understanding of the present disclosure, and are not intended to limit the scope of the present disclosure. Therefore, it should be construed that all modifications and changes or modified and changed forms based on the technical idea of the present disclosure fall within the scope of the present disclosure.

While the present disclosure has been shown and described with reference to certain embodiments thereof, it will be apparent to those of ordinary skill in the art that various changes in form and detail may be made thereto without departing from the spirit and scope of the present disclosure as defined by the following claims.

What is claimed is:

1. An electronic device, comprising:
a first processor that monitors whether screen updating is delayed based on a reference time associated with the screen updating, and generates a control signal that controls a screen updating time based on whether the screen updating is delayed; and
a clock managing unit that controls a clock that is supplied to the electronic device in response to the control signal.

2. The electronic device of claim 1, wherein the first processor measures the screen updating time in real time, and determines whether the screen updating is delayed by comparing the measured time to the reference time.

3. The electronic device of claim 1, wherein the control signal controls the clock managing unit so as to increase a clock frequency supplied to the first processor to a predetermined frequency.

4. The electronic device of claim 1, wherein the first processor monitors whether the screen updating is delayed based on a frame rate corresponding to the screen updating, and generates the control signal to increase the frame rate based on whether the screen updating is delayed.

5. The electronic device of claim 1, wherein the first processor executes a monitoring module that monitors whether the screen updating is delayed, and the monitoring module comprises:
a measuring module that measures the screen updating time;
a comparing module that compares the reference time to the measured time; and
a control module that generates the control signal to control the clock based on a result of the comparison.

6. The electronic device of claim 1, wherein the clock managing unit controls the clock that is supplied to at least one of the first processor, a memory interface, and an input/output interface of the electronic device in response to the control signal.

7. The electronic device of claim 1, further comprising:
a power managing unit that controls power supplied to the first processor in response to the control signal.

8. The electronic device of claim 7, wherein the control signal controls the power managing unit to increase a voltage supplied to the first processor to a predetermined voltage.

9. The electronic device of claim 1, further comprising:
a second processor,
wherein the first processor monitors whether the screen updating is delayed, and determines whether to operate the second processor based on whether the screen updating is delayed.

10. The electronic device of claim 9, wherein the first processor executes a monitoring module that monitors whether the screen updating is delayed, and the monitoring module comprises:
a measuring module that measures the screen updating time;
a comparing module that compares the reference time to the measured time; and
a control module that determines whether to operate the second processor based on a result of the comparison.

11. The electronic device of claim 1, wherein the screen updating time is from a drawing start point of a frame corresponding to the screen updating to a drawing end point of the frame.

12. The electronic device of claim 1, wherein the reference time is set by a user or a program, based on the first processor.

13. An operation method of an electronic device, the method comprising:
measuring a screen updating time, and monitoring whether screen updating is delayed based on a reference time associated with the screen updating and the measured time; and
controlling a clock supplied to the electronic device, so as to control the screen updating time based on whether the screen updating is delayed.

14. The method of claim 13, wherein monitoring whether the screen updating is delayed comprises:
measuring the screen updating time in real time, and determine whether the screen updating is delayed by comparing the measured time to the reference time.

15. The method of claim 13, wherein controlling the clock comprises:
controlling the clock to increase, to a predetermined frequency, a clock frequency supplied to a processor that controls the screen updating time.

16. The method of claim 13, wherein measuring the screen updating time comprises:
measuring a time from a drawing start point of a frame corresponding to the screen updating to a drawing end point of the frame.

17. The method of claim 13, wherein controlling the clock comprises:
controlling the clock to increase a frame rate associated with the screen updating based on a result of monitoring.

18. The method of claim 13, further comprising:
controlling power supplied to a processor that controls the screen updating time, based on whether the screen updating is delayed.

19. The method of claim 13, wherein setting the reference time comprises:
setting the reference time by a user or a program, based on a processor included in the electronic device.

20. The method of claim 13, wherein controlling the clock supplied to the electronic device comprises:
controlling the clock supplied to at least one of the processor, a memory interface, and an input/output interface of the electronic device.
